(19) United States
(12) Patent Application Publication
(10) Pub. No.: US 2012/0097052 A1
(43) Pub. Date: Apr. 26, 2012

(54) DISPLAY DEVICE WITH JUICE EXTRACTING FUNCTION

(76) Inventors: Wen-Hung HUANG, Taipei County (TW); Guan-De Liou, Taipei City (TW)

(21) Appl. No.: 13/033,248

(22) Filed: Feb. 23, 2011

(30) Foreign Application Priority Data
Oct. 20, 2010 (TW) 99135749

(51) Int. Cl. A23N 1/00

(52) U.S. Cl. 99/506

(57) ABSTRACT

A display device with juice extracting function includes a base body, a displaying unit, a juice extracting module and a locking member. The displaying unit is connected to the base body in a rotatable manner, so as to rotate against the base body. And the displaying unit is provided to receive image signals to display images. The juice extracting module is disposed on the base body, and provides the juice extracting function. The locking member connects the juice extracting module to the displaying unit, and the rotation of the displaying unit drives the juice extracting module. Through rotation of the displaying unit against the base body, the juice extracting module is driven to squeeze a vegetable or fruit.

### CROSS-REFERENCES TO RELATED APPLICATIONS

This non-provisional application claims priority under 35 U.S.C. §119(a) on Patent Application No. 99135749 filed in Taiwan, R.O.C. on 2010 Oct. 20, the entire contents of which are hereby incorporated by reference.

### BACKGROUND OF THE INVENTION

1. Field of Invention

The present invention relates to a display device; and more particularly to a display device with juice extracting function.

2. Related Art

Display devices are used in a wide range of applications, such as a desktop computer, and the computer is operated to run programs and display various images on the display device. With the development of science and technology, the manufactures continue to improve to provide thinner and better image quality display devices.

However, except for the function of displaying information, display devices currently available on the market have no other functions. As is well known, a display device is reasonably heavy, and generally equipped a base body to support the display device and to be used in an upright position. In addition, in order to support the weight of the display device, the base body is usually wider than the display device. Therefore, when the display device is placed on a desk, the base body occupies a large area of the desk. Although display devices are typically heavy, with recent technological advances have produced much thinner display devices; as a result, only a thin screen exists on the base body, leaving unused space above the base body.

Furthermore, common household juicer is operated manually to extract juice, which is painstaking and likely to have muscle soreness in the arms. Therefore, discovering a method of using the weight of the display apparatus to operate the juicer, so as to improve the flexibility by which a user can configure and use the display device space, is a problem urgently awaiting a solution.

### SUMMARY OF THE INVENTION

Accordingly, the present invention is directed to a display device with juice extracting function, which can properly use the extra space above the base body and overcome the inconvenience of extracting juice by manually pressing.

The present invention provides a display device with juice extracting function, which includes a base body, a displaying unit, a juice extracting module and a locking member. The displaying unit is connected to the base body in a rotatable manner, so as to rotate against the base body, and is adapted to receive an image signal to display an image. The juice extracting module is disposed on the base body, and provides the juice extracting function. The locking member connects the juice extracting module to the displaying unit, and pushing on the displaying unit drives the juice extracting module to have a squeezing motion.

Through pushing on the displaying unit against the base body, the juice extracting module is driven to squeeze a vegetable or fruit put in the juice extracting module.

In one or more embodiments of the present invention, a joint groove with at least one open end is provided on a top surface of the base body, and the juice extracting module further includes a joint block disposed at the bottom of a cup inside the juice extracting module. The joint block matches the joint groove to fix the cup on the base body.

In one or more embodiments of the present invention, the display device with juice extracting function further includes a pivot connect member, providing at least one rotational degree of freedom to the displaying unit, and the pivot connect member connects the displaying unit and the base body.

In one or more embodiments of the present invention, the pivot connect member includes a shaft, a first arm and a second arm. The shaft provides the rotational degree of freedom to the displaying unit; the first arm and the second arm are connected with each other through the shaft, in which the first arm and the second arm are respectively connected with the displaying unit and the base body.

In one embodiment of the present invention, the juice extracting module further includes a cup, a compressor and a cover. The cup is provided with an accommodating space defined therein, and the cup has an opening in communication with the accommodating space. The compressor and the cup are connected with each other, and the compressor includes a bottom plate and a side wall, in which the side wall extends at an edge of the bottom plate and encircles the bottom plate, the bottom plate is adapted to seal the accommodating space. The bottom plate further includes at least one flow-through hole for communicating with the accommodating space. The cover is connected with the displaying unit through the locking member, and is located above the compressor.

In one embodiment of the present invention, the compressor further includes a convex part, which is disposed on the bottom plate and surrounded by the side wall; the cover has a concave part towards the convex part.

In another embodiment of the present invention, the compressor further has a combining part, which is formed on the bottom plate to be combined with the opening of the cup.

In one or more embodiments of the present invention, a hook is formed on one end of the locking member, and the locking member is pivoted on the cover.

In one embodiments of the present invention, a sliding slot is further disposed on the cover, and a protrusion rod is disposed on another end of the locking member. When the locking member rotates, the protrusion rod slides through the sliding slot so that the cover is combined with the displaying unit through the hook.

The detailed features and advantages of the present invention will be described in the embodiment below, the content of which is sufficient for those skilled in the art to comprehend and implement the technical content of the present invention. The objectives and advantages of the present invention are comprehensible to those skilled in the art according to the content, claims and drawings of the disclosure.

### BRIEF DESCRIPTION OF THE DRAWINGS

FIG. 1 is cross-sectional view of a display device with juice extracting function according to an embodiment of the present invention;

FIG. 2 is back view of the display device with juice extracting function according to the embodiment of the present invention;

FIG. 3 is a cross-sectional view of a juice extracting module according to the embodiment of the present invention;

FIG. 4 is a cross-sectional view of a cup according to the embodiment of the present invention;

FIG. 5 is a top view of a cup according to the embodiment of the present invention;

FIG. 6 is a cross-sectional view of a compressor according to the embodiment of the present invention;

FIG. 7 is a top view of a compressor according to the embodiment of the present invention;

FIG. 8 is a schematic view showing the cover combined with the displaying unit according to the embodiment of the present invention;

FIG. 9 is a schematic view showing the juice extracting module combined with the base body according to the embodiment of the present invention; and

FIG. 10 is a schematic view showing the motion of the displaying unit extracting juice through the juice extracting module according to the embodiment of the present invention.

### DETAILED DESCRIPTION OF THE INVENTION

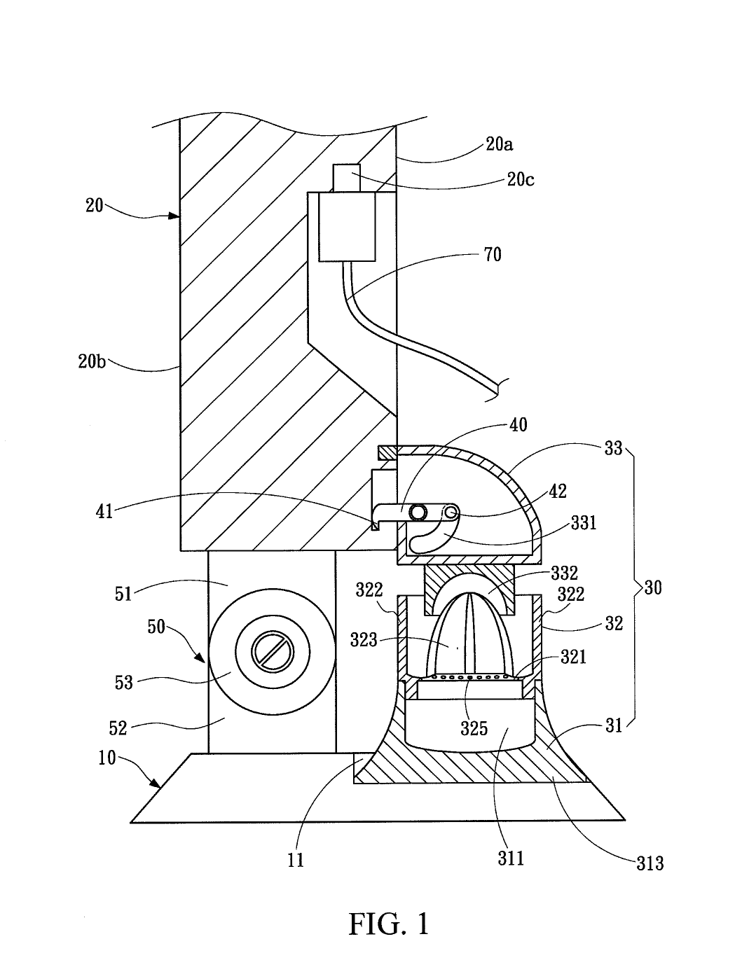

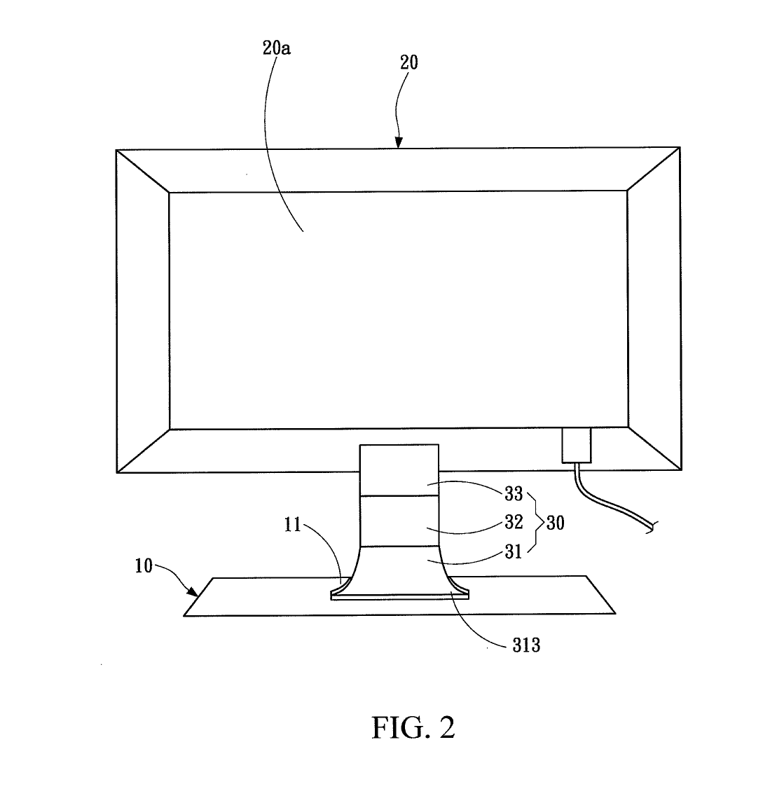

FIG. 1 and FIG. 2 show a display device with juice extracting function according to an embodiment of the present invention, and the display device with juice extracting function includes a base body 10, a displaying unit 20, a juice extracting module 30 and a locking member 40.

Please refer to FIG. 1 and FIG. 2, in which the base body 10 is placed on a planar surface, such as a desk. A joint groove 11, such as a dovetail groove, is provided on a top surface of the base body 10, and at least one end of the joint groove 11 is an open end.

Please refer to FIG. 1 and FIG. 2, in which the displaying unit 20 has a back surface 20a and a screen 20b on the front of the displaying unit 20. An electrical connection port 20c, such as a D-Sub, DVI, or HDMI connection port, is disposed on the back surface 20a to provide connection for a video transmission cable 70, so that the displaying unit 20 receives image signals generated by an electronic device through the video transmission cable 70 and the electrical connection port 20c, and thus images are displayed on the screen 20b.

Please refer to FIG. 1 and FIG. 2, in which the display device with juice extracting function according to the embodiment of the present invention further includes a pivot connection member 50. The pivot connect member 50 provides at least one rotational degree of freedom to the displaying unit 20. The pivot connection member 50 is adapted to connect the displaying unit 20 and the base body 10, so that the displaying unit 20 is connected to the base body 10 in a rotatable manner. In one example of the pivot connect member 50, the pivot connection member 50 includes a first arm 51, a second arm 52 and a shaft 53. The first arm 51 and the second arm 52 are connected with each other through the shaft 53, and the first arm 51 and the second arm 52 are respectively connected with the displaying unit 20 and the base body 10, so as to provide the rotational degree of freedom to the displaying unit 20 through the shaft 53.

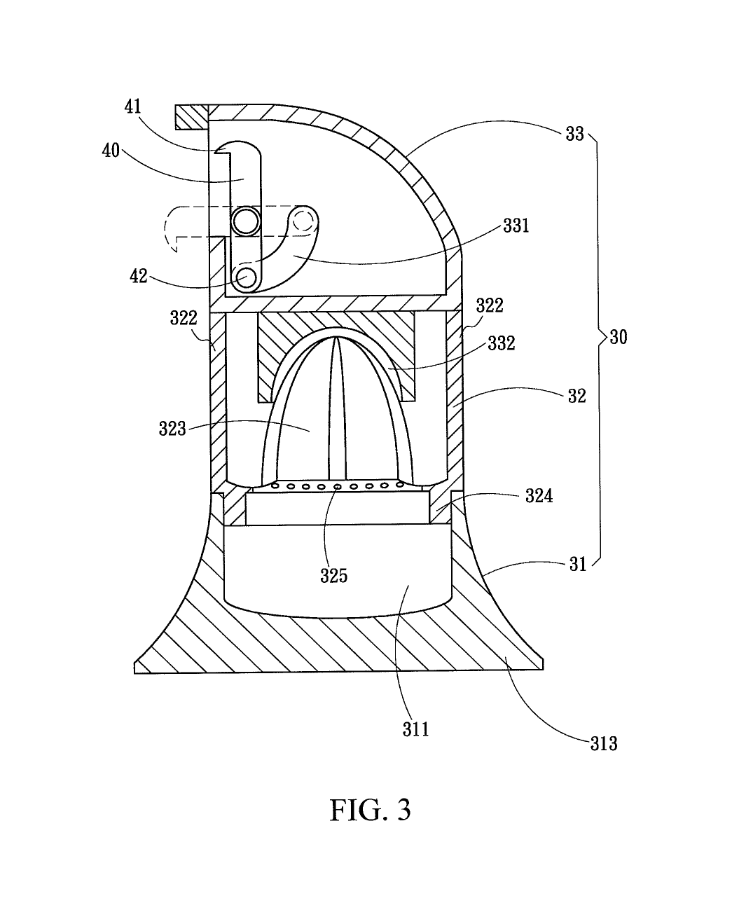

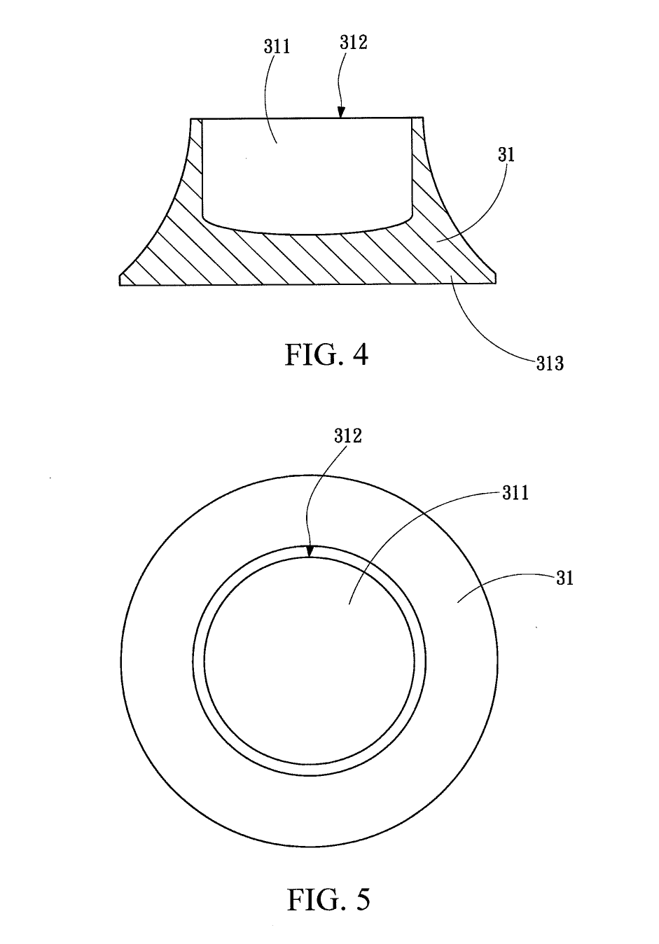

Please refer to FIG. 3, FIG. 4 and FIG. 5, in which the juice extracting module 30 is disposed on the base body 10, so as to provide a juice extracting function. The juice extracting module 30 includes a cup 31, a compressor 32, and a cover 33. The cup 31 is provided with an accommodating space 311 defined therein, and the cup 31 has an opening 312 in communication with the accommodating space 311. The juice extracting module 30 further has a joint block 313, which is disposed at the bottom of the cup 31 The joint block 313 matches the joint groove 11 on the base body 10 to attach the cup 31 to the base body 10.

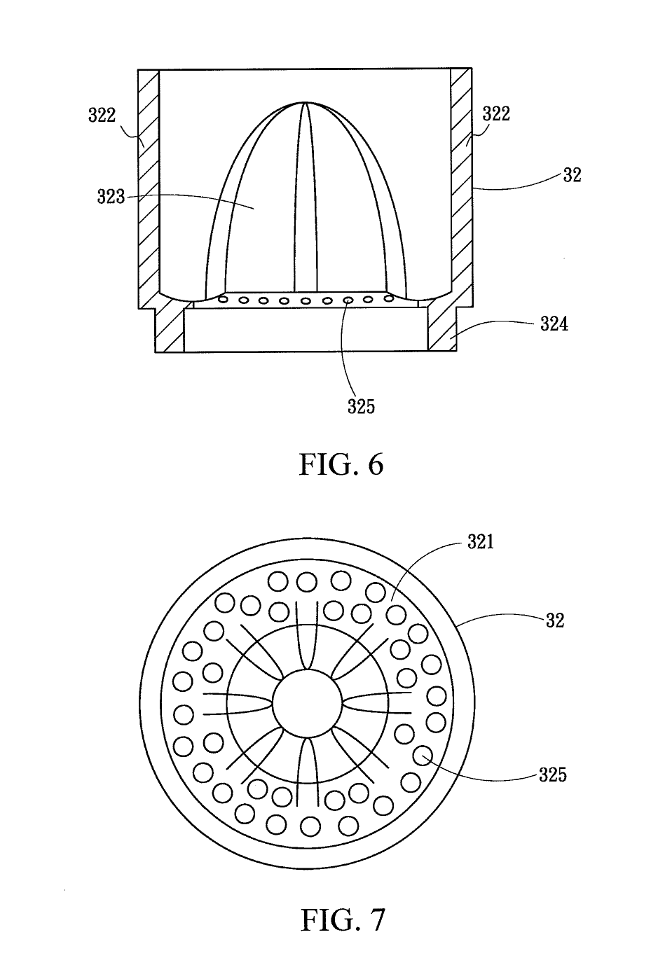

Please refer to FIG. 6 and FIG. 7, in which the compressor 32 includes a bottom plate 321, a side wall 322 and a convex part 323. The side wall 322 extends at the edge of the bottom plate 321 and encircles the bottom plate 321. The convex part 323 is disposed in the center and on the bottom plate 321 surrounded by the side wall 322.

The compressor 32 further has a combining part 324 formed on the bottom side of the bottom plate 321. The compressor 32 is to be combined with the opening 312 of the cup 31, so that the compressor 32 and the cup 31 are connected with each other, and the bottom plate 321 seals the accommodating space 311 of the cup 31. Preferably, the compressor 32 and the cup 31 are connected in a screw tight manner through threads; this connection manner is only an example, and is not intended to limit the present invention. Corresponding buckling parts may be disposed on the compressor 32 and the cup 31 for a buckling connection. The bottom plate 321 further has at least a flow-through hole 325 for communication with the accommodating space 311.

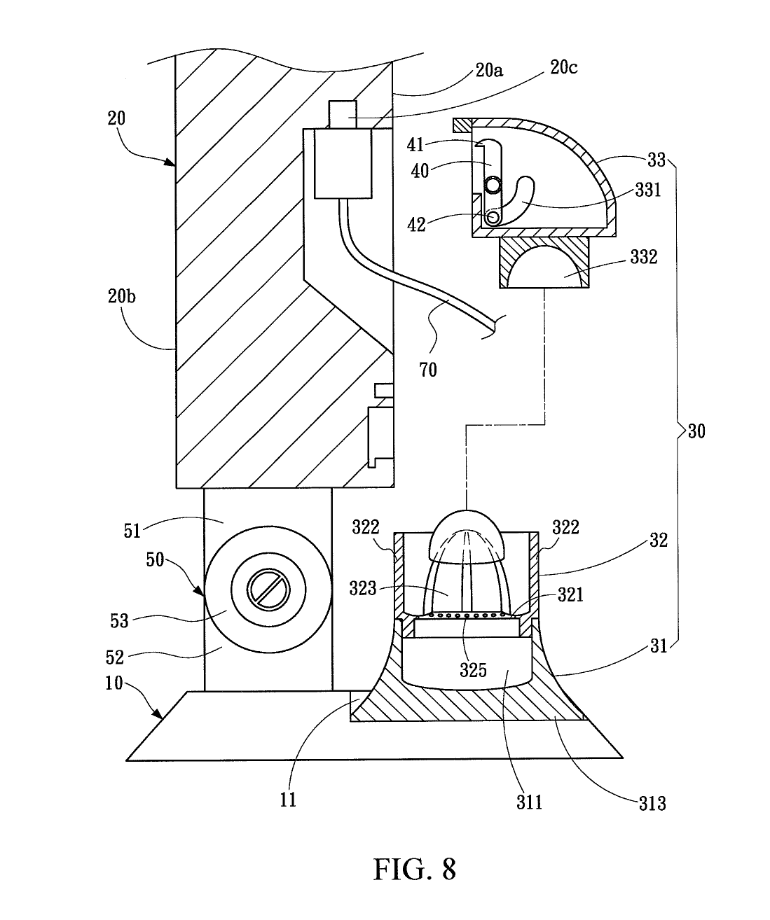

Please refer to FIG. 8, in which the cover 33 is connected to the back surface 20a of the displaying unit 20 through the locking member 40 and is located above the compressor 32. The locking member 40 connects the cover 33 to the displaying unit 20, and pushing on the displaying unit 20 drives the juice extracting unit 30 in a squeezing motion.

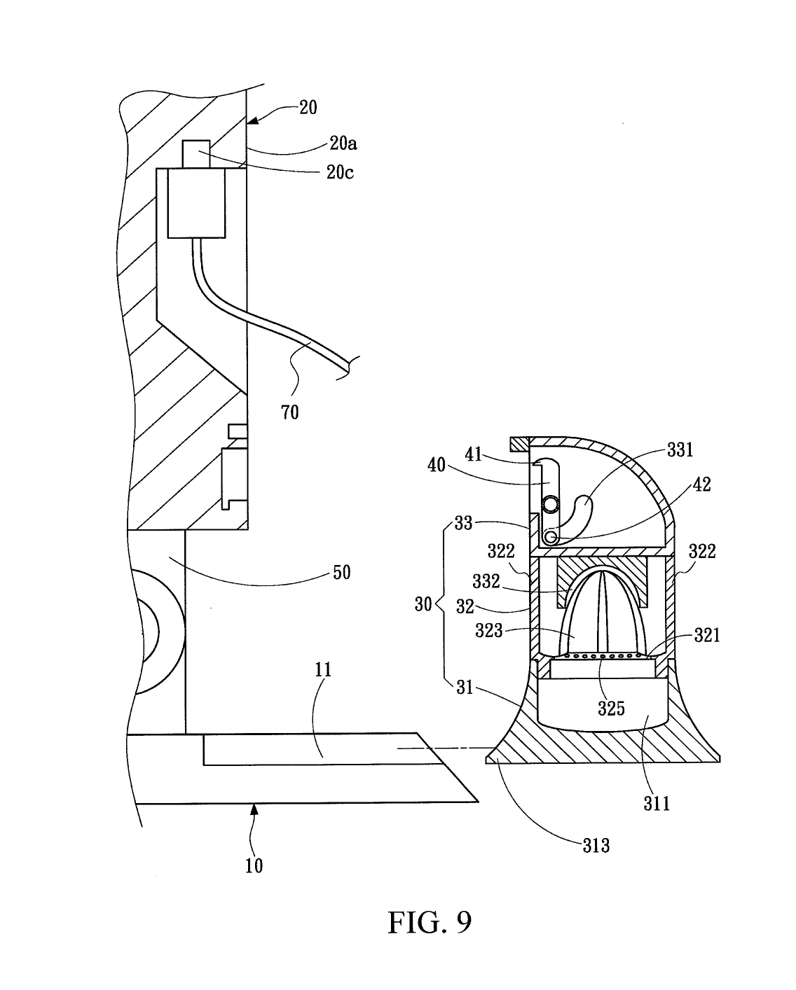

FIG. 1, FIG. 3, FIG. 8 and FIG. 9 show an example of the locking member 40 of the present invention. A preferred implementation of the locking member 40 is to make the cover 33 rotatable, connected with the displaying unit 20 in a sliding manner, and capable of being detached from the displaying unit 20 conveniently. In the example of the locking member 40, a hook 41 is formed on one end of the locking member 40, and a protrusion rod 42 is disposed on the other end. A sliding slot 331 is further disposed on the side of the cover 33, and the sliding slot 331 extends along an arc path. The locking member 40 is pivoted on the cover 33, so that the hook 41 is located outside the cover 33 or accommodated in the cover 33 through the rotation of the locking member 40. When the locking member 40 rotates, the protrusion rod 42 slides through the sliding slot 331, so that the cover 33 is attached to the displaying unit 20 through the hook 41.

Please refer to FIG. 6 and FIG. 8, in which the convex part 323 of the compressor 32 protrudes towards the direction away from the accommodating space 311 of the cup 31, and the cover 33 has a concave part 332 towards the convex part 323, so as to enhance the juice extracting.

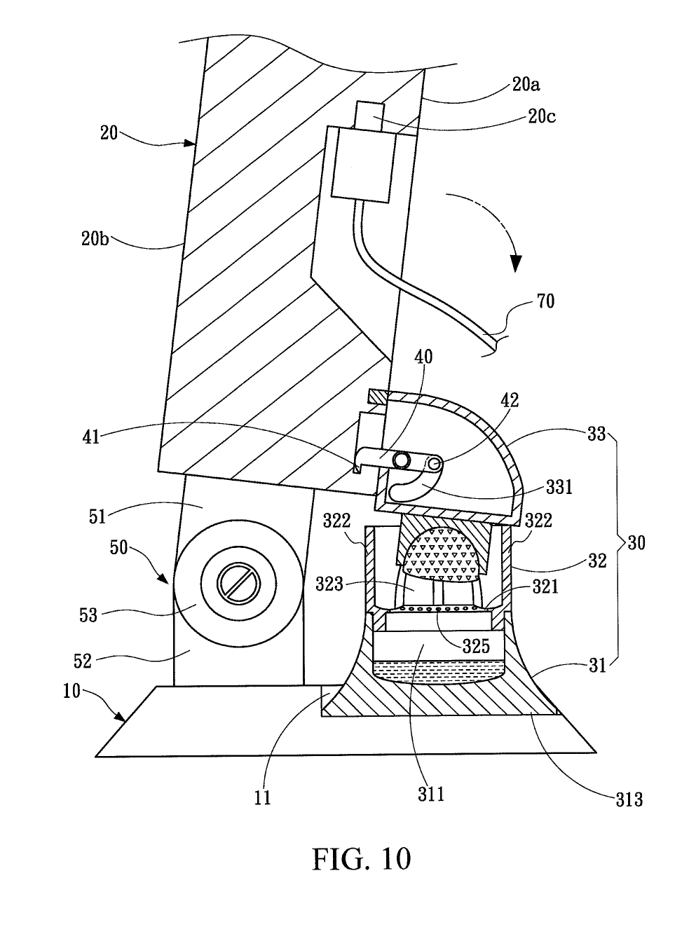

Please refer to FIG. 9 and FIG. 10, in which when using the display device according to the embodiment of the present invention, a user should first assemble the juice extracting module 30 on the base body 10. The joint block 313 of the cup 31 slides into the joint groove 11 of the base body 10, so that the cup 31 is fixed on the base body 10. After the user turns the protrusion rod 42 of the locking member 40 along the sliding slot 331 of the cover 33, the locking member 40 rotates to make the hook 41 caught in a catch slot on the back surface 20a of the displaying unit 20, and attached the cover 33 to the back surface 20a of the displaying unit 20.

Please refer to FIG. 10, in which the displaying unit 20 tilts backward through the rotation of the displaying unit 20, and the displaying unit 20 drives the juice extracting module 30 to drive the cover 33 to push the compressor 32, so as to squeeze vegetables or fruits placed between the cover 33 and the compressor 32, such as a cut fruit placed therebetween. Liquid produced by squeezing flows to the accommodating space 311 through the flow-through hole 325, and the extracted juice is stored in the accommodating space 311.

The present invention uses the displaying unit 20 in combination with the juice extracting module 30 to extract juice. Through the combination of both, the weight of the displaying unit is used to squeeze the fruit when the juice is extracted by manual pressing, which saves labor, and solves the problem that the juice extractor in the prior art is likely to have muscle soreness in the arms. Furthermore, the displaying unit 20 and the juice extracting module 30 are combined above the base body 10, thus improving the flexibility by which a user can configure and use the display device space.

While the present invention has been described by the way of example and in terms of the preferred embodiments, it is to be understood that the invention need not to be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A display device with juice extracting function, comprising:
a base body;
a displaying unit, connected to the base body in a rotatable manner, so as to rotate against the base body;
a juice extracting module, disposed on the base body to provide the juice extracting function; and
a locking member, connecting the juice extracting module to the displaying unit; wherein the rotation of the displaying unit drives the juice extracting module to squeeze.

2. The display device with juice extracting function as claimed in claim 1, wherein a joint groove with at least one open end is provided on a top surface of the base body, and the juice extracting module further comprises a joint block disposed at the bottom of a cup of the juice extracting module, and the joint block matches the joint groove to fix the cup on the base body.

3. The display device with juice extracting function as claimed in claim 1, further comprising a pivot connection member connecting the displaying unit to the base body and providing at least one rotational degree of freedom to the displaying unit.

4. The display device with juice extracting function as claimed in claim 3, wherein the pivot connection member comprises:
a shaft, providing at least one rotational degree of freedom; and
a first arm and a second arm, connected with each other through the shaft, and respectively connected with the displaying unit and the base body.

5. The display device with juice extracting function as claimed in claim 1, wherein the juice extracting module further comprises:
a cup having an accommodating space defined therein and an opening in communication with the accommodating space;
a compressor, connected with the cup, comprising a bottom plate and a side wall, wherein the side wall extends at an edge of the bottom plate and encircles the bottom plate; the bottom plate is adapted to seal the accommodating space, and the bottom plate further comprises at least one flow-through hole for communication with the accommodating space; and
a cover, connected with the displaying unit through the locking member, and located above the compressor.

6. The display device with juice extracting function as claimed in claim 5, wherein the compressor further comprises a convex part disposed on the bottom plate and surrounded by the side wall, and the cover has a concave part towards the convex part.

7. The display device with juice extracting function as claimed in claim 5, wherein the compressor further has a combining part formed on the bottom plate to be combined with the opening of the cup.

8. The display device with juice extracting function as claimed in claim 1, wherein a hook is formed on one end of the locking member, and the locking member is pivoted on the cover.

9. The display device with juice extracting function as claimed in claim 8, wherein a sliding slot is further provided on the cover, and a protrusion rod is further provided on another end of the locking member; and the protrusion rod slides through the sliding slot when the locking member rotates to combine the cover with the displaying unit through the hook.

10. The display device with juice extracting function as claimed in claim 9, wherein the sliding slot extends along an arc path.
